(19) United States
(12) Patent Application Publication
(10) Pub. No.: US 2026/0267166 A1
(43) Pub. Date: Sep. 10, 2026

(54) OPTICAL LENS INTENDED TO BE WORN BY A WEARER

(71) Applicant: Essilor International, Charenton-Le-Pont (FR)

(72) Inventors: Matthieu GUILLOT, Charenton Le Pont (FR); Patrick HUGONNEAUX, Charenton Le Pont (FR); Guillaume GED, Charenton Le Pont (FR)

(73) Assignee: Essilor International, Charenton-Le-Pont (FR)

(21) Appl. No.: 18/868,026

(22) PCT Filed: Jun. 8, 2023
(86) PCT No.: PCT/EP2023/065341

§ 371 Date: Nov. 21, 2024

(30) Foreign Application Priority Data
Jun. 9, 2022 (EP) 22305836.3

(51) Int. Cl. G02C 7/04

(52) U.S. Cl. CPC G02C 7/049

(57) ABSTRACT

An optical lens intended to be worn by a wearer, the optical lens including a refraction area having a refractive power based on a prescription of the wearer, and a plurality of optical elements each having a transparent optical function of not focusing an image on the retina of the eye of the wearer when the optical lens is worn in standard wearing conditions, the 60° specular gloss levels over a central zone, for example at the optical center, of the optical lens and over a periphery zone of the optical lens being similar.

### TECHNICAL FIELD

The disclosure relates to an optical lens intended to be worn by a wearer comprising a refraction area having a refractive power based on a prescription for the eye of the wearer and a plurality of optical elements each having a transparent optical function of not focusing an image on the retina of the eye of the wearer when the optical lens is worn in standard wearing conditions.

### BACKGROUND OF THE DISCLOSURE

Myopia of an eye is characterized by the fact that the eye focuses distant objects in front of its retina. Myopia is usually corrected using a concave lens and hyperopia is usually corrected using a convex lens.

Myopia, also referred as to short-sightedness, has become a major public health problem worldwide. Accordingly, a large effort has been made to develop solutions aiming to slow down myopia progression.

Most of the recent management strategies for myopia progression involved acting on the peripheral vision using optical defocus. This approach has received a great deal of interest since works in chicks and primates showed that foveal refractive error could be manipulated through peripheral optical defocus without the involvement of an intact fovea. Several methods and products are used to slow down myopia progression by inducing such peripheral optical defocus. Among these solutions, orthokeratology contact lenses, soft bifocal and progressive contact lenses, circular progressive ophthalmic lenses, and lenses with array of lenslets have been shown to be more or less effective, through randomized controlled trials.

Myopia control solutions with array of lenslets have been proposed, in particular by the applicant. The purpose of this array of lenslets is to provide an optical blurred image, in front of the retina, triggering a stop signal to the eyes growth, while enabling a good vision.

Most studies focus on configuring the myopia control solution to provide the best myopia control. However, most of the myopia control solution are to be used by children or teenagers that may be very influenced by the aesthetic aspect of the myopia control solution. For such myopia control solution to work the best, the wearer is to wearer the optical lens as long as possible during the day.

Therefore, there is a need to provide optical lenses comprising optical elements each having a transparent optical function of not focusing an image on the retina of the wearer where the optical elements are as unobtrusive as possible to increase the level of acceptance of the solution, in particular among children and teenagers.

### SUMMARY OF THE DISCLOSURE

To this end, the disclosure proposes an optical lens intended to be worn by a wearer comprising:
a refraction area having a refractive power based on a prescription of the wearer;
a plurality of optical elements each having a transparent optical function of not focusing an image on the retina of the eye of the wearer when the optical lens is worn in standard wearing conditions,
   wherein the 60° specular gloss levels over a central zone, for example at the optical center, of the optical lens and over a periphery zone, for example at the periphery, of the optical lens are similar.

Advantageously, having similar 60° specular gloss levels over a central zone, for example at the optical center, of the optical lens and over a periphery zone, for example at the periphery, of the optical lens increase the aesthetic aspect of the optical lens. In particular, having similar 60° specular gloss levels over a central zone, for example at the optical center, of the optical lens and over a periphery zone, for example at the periphery, of the optical lens allows having an optical lens that appears from an observer point of view similar to a usual single vision optical lens although said optical lens comprises a plurality of optical elements.

Indeed, the in human vision the retinal detection of contrasts is of great importance. Gloss level is one of the visual appearance attributes and as such one of the important entry stimulus to the total visual appearance determination. This implies that gloss gradients, measurable on the lens surface, increase the visibility of optical elements, for example microlenses, to the observers.

The inventors have determined that the more uniform the optical lens is, the more aesthetical it is judged by observers. In the ophthalmic lens industry, single vision optical lenses are a striking example that non visually uniform lenses are not well accepted by wearer.

The 60° specular gloss levels over a central zone, for example at the optical center, of the optical lens and over a periphery zone, for example at the periphery, of the optical lens over are measured using the same glossmeter. Hence the inter instrument reproducibility is not taken into account in the disclosure.

According to further embodiments which can be considered alone or in combination:
overlapping of measured gloss level over a central zone, for example the optical center and over a periphery zone, for example at the periphery, of the lens corresponds to similar values; and/or
the standard deviations of the 60° specular gloss levels measured over a central zone, for example at the optical center, of the optical lens and over a periphery zone, for example at the periphery, of the optical lens overlap; and/or
the average distinctness of image gloss (DOI) measured over a central zone, for example at the optical center, of the optical lens and over a periphery zone, for example at the periphery, of the optical lens are greater than or equal to 10 DOI Index; and/or
at least part of one of the front or back surface of the optical lens comprises at least one layer of at least one coating element covering at least part of the surfaces on which the optical elements are placed; and/or
at least 50%, for example at least 80%, for example all, of the optical elements are located on one of the surfaces of the optical lens, for example the front surface of the optical lens; and/or
at least 50%, for example at least 80%, for example all, of the optical elements are located between the front and the back surfaces of the optical lens; and/or
at least 50%, for example at least 80%, for example all, of the optical elements are refractive lenslets; and/or
at least 50%, for example at least 80%, for example all, of the optical elements are positioned along at least 5 concentric rings and wherein the concentric rings are none contiguous one with the others; and/or
the difference of standard deviation of the 60° specular gloss levels measured over a central zone, for example at the optical center, of the optical lens and over a periphery zone, for example at the periphery, of the optical lens is smaller than or equal to 2 GU; and/or
the standard deviations of the distinctness of image gloss (DOI) measured over a central zone, for example at the optical center, of the optical lens and over a periphery zone, for example at the periphery, of the optical lens overlap; and/or
at least 50%, for example at least 80%, for example all, of the optical elements are positioned on a structured mesh, the structured mesh being a squared mesh or a honeycomb mesh or a triangle mesh or an octagonal mesh; and/or
the difference of standard deviation of the 60° specular gloss levels measured over a central zone, for example at the optical center, of the optical lens and over a periphery zone, for example at the periphery, of the optical lens is greater than or equal to 5 GU; and/or
the standard deviation of the 60° specular gloss level measured over a periphery zone, for example at the periphery, of the optical lens is smaller than or equal to 2 GU; and/or
the standard deviations of the distinctness of image gloss (DOI) measured over a central zone, for example at the optical center, of the optical lens and over a periphery zone, for example at the periphery, of the optical lens do not overlap; and/or
the standard deviations of the distinctness of image gloss (DOI) measured over a periphery zone, for example at the periphery, of the optical lens is smaller than or equal to 2 DOI Index; and/or
the refraction area is formed as the area other than the areas formed as the plurality of optical elements; and/or
the area of each optical elements is greater than or equal to 0.4 mm² and smaller than or equal to 5 mm², for example smaller than or equal to 4 mm²; and/or
the ratio of the total area of the optical elements with respect to the total area of the surface of the optical lens is greater than or equal 20% and smaller than or equal to 80%; and/or
at least 50%, for example 80%, for example all, of the optical elements are multifocal lenslets; and/or
at least 50%, for example 80%, for example all, of the optical elements are diffractive lenslets; and/or
the diffractive lenses are contiguous diffractive lenslets; and/or
at least 50%, for example at least 80%, for example all, of the optical elements are diffusive lenslets; and/or
at least 50%, for example at least 80%, for example all, of the optical elements are located on the back surface of the lens element; and/or
for every circular zone having a radius comprised between 2 and 4 mm comprising a geometrical center located at a distance of the framing reference that faces the pupil of the user gazing straight ahead in standard wearing conditions greater or equal to said radius+5 mm, the ratio between the sum of areas of the parts of optical elements located inside said circular zone and the area of said circular zone is comprised between 20% and 70%; and/or
the optical lens further comprises at least four optical elements organized in at least two groups of contiguous optical elements; and/or
each group of contiguous optical element is organized in at least two concentric rings having the same center, the concentric ring of each group of contiguous optical element being defined by an inner diameter corresponding to the smallest circle that is tangent to at least one optical element of said group and an outer diameter corresponding to the largest circle that is tangent to at least one optical elements of said group; and/or
at least part of, for example all the concentric rings of optical elements are centered on the optical center of the surface of the lens element on which said optical elements are disposed; and/or
the concentric rings of optical elements have a diameter comprised between 9.0 mm and 60 mm; and/or
the distance between two successive concentric rings of optical elements is greater than or equal to 0.5 mm, the distance between two successive concentric rings being defined by the difference between the outer diameter of a first concentric ring and the inner diameter of a second concentric ring, the second concentric ring being closer to the periphery of the optical lens; and/or
the plurality of optical elements further comprises optical elements positioned radially between two concentric rings; and/or
the mesh structure is a random mesh, for example a Voronoid mesh; and/or
at least 50%, for example at least 80%, for example all, of the optical elements have a constant optical power and a discontinuous first derivative between two contiguous optical elements; and/or
at least 50%, for example at least 80%, for example all, of the optical elements have a varying optical power and a continuous first derivative between two contiguous optical elements; and/or
the optical elements are configured so that along at least one, section of the lens element, for example a section passing by the optical center of the optical lens, the mean sphere of optical elements increases from a point of said section, for example the optical center of the optical lens, towards the peripheral part of said of the optical lens; and/or
the optical elements are configured so that along at least one section of the optical lens the cylinder power of optical elements increases from a point of said section, for example the optical center of the optical lens, towards the peripheral part of said of the optical lens; and/or
the optical elements are configured so that along the at least one section of the optical lens the mean sphere and/or the cylinder of optical elements increases from the center of said section towards the peripheral part of said section; and/or
the refraction area comprises an optical center and the optical elements are configured so that along at least 20%, for example at least 50%, for example at least 80%, for example all, section passing through the optical center of the lens the mean sphere and/or the cylinder power of the optical elements increases from the optical center towards the peripheral part of the lens; and/or
the refraction area comprises a far vision reference point, a near vision reference, and a meridian joining the far and near vision reference points, the optical elements are configured so that in standard wearing conditions along any horizontal section of the lens the mean sphere and/or the cylinder of the optical elements increases from the intersection of said horizontal section with the meridian towards the peripheral part of the optical lens; and/or
the mean sphere and/or the cylinder power increasing functions along the sections are different depending on the position of said section along the meridian; and/or
the mean sphere and/or the cylinder power increasing functions along the sections are unsymmetrical; and/or
the optical elements are configured so that in standard wearing conditions the at least one section is a horizontal section; and/or
the mean sphere and/or the cylinder power of optical elements increases from a first point of said section towards the peripheral part of said section and decreases from a second point of said section towards the peripheral part of said section, the second point being closer to the peripheral part of said section than the first point; and/or
the mean sphere and/or the cylinder power increasing function along the at least one section is a Gaussian function; and/or
the mean sphere and/or the cylinder power increasing function along the at least one section is a Quadratic function; and/or
the optical elements are configured so that the mean focus of the light rays passing through each optical element is at a same distance to the retina;
and/or
at least one, for example all, of the optical elements is a toric refractive lenslet.

### BRIEF DESCRIPTION OF THE DRAWINGS

Non-limiting embodiments of the disclosure will now be described with reference to the accompanying drawing wherein:

FIG. 1 illustrates a front view of a lens element according to first embodiment of the disclosure;

FIG. 2 illustrates a profile view a lens element according to an embodiment of the disclosure;

FIG. 3 illustrates a front view of a lens element according to a second embodiment of the disclosure;

FIG. 4 illustrates the astigmatism axis y of a lens in the TABO convention;

FIG. 5 illustrates the cylinder axis γ_{AX} in a convention used to characterize an aspherical surface;

FIG. 6 illustrates a pattern of measurements that may be carried out for measuring the 60° specular gloss level and the distinctness of image gloss;

FIG. 7 provides measurements of 60° specular gloss level in central and periphery of two different optical lenses according to the disclosure; and

FIG. 8 provides measurements of the distinctness of image gloss in central and periphery of two different optical lenses according to the disclosure.

Elements in the figures are illustrated for simplicity and clarity and have not necessarily been drawn to scale. For example, the dimensions of some of the elements in the figure may be exaggerated relative to other elements to help to improve the understanding of the embodiments of the present disclosure.

### DETAILED DESCRIPTION OF EMBODIMENTS OF THE DISCLOSURE

The disclosure relates to a lens element intended to be worn by a wearer.

In the reminder of the description, terms like «up», «bottom», «horizontal», «vertical», «above», «below», «front», «rear» or other words indicating relative position may be used. These terms are to be understood in the wearing conditions of the lens element.

In the context of the present disclosure, the term “optical lens” can refer to an uncut optical lens or a spectacle optical lens edged to fit a specific spectacle frame or an ophthalmic lens and an optical device adapted to be positioned on the ophthalmic lens. The “optical lens” in the context of the present disclosure may have a coating such as a hardcoat.

According to some embodiments, the optical lens is a contact lens intended to be worn on an eye of a wearer.

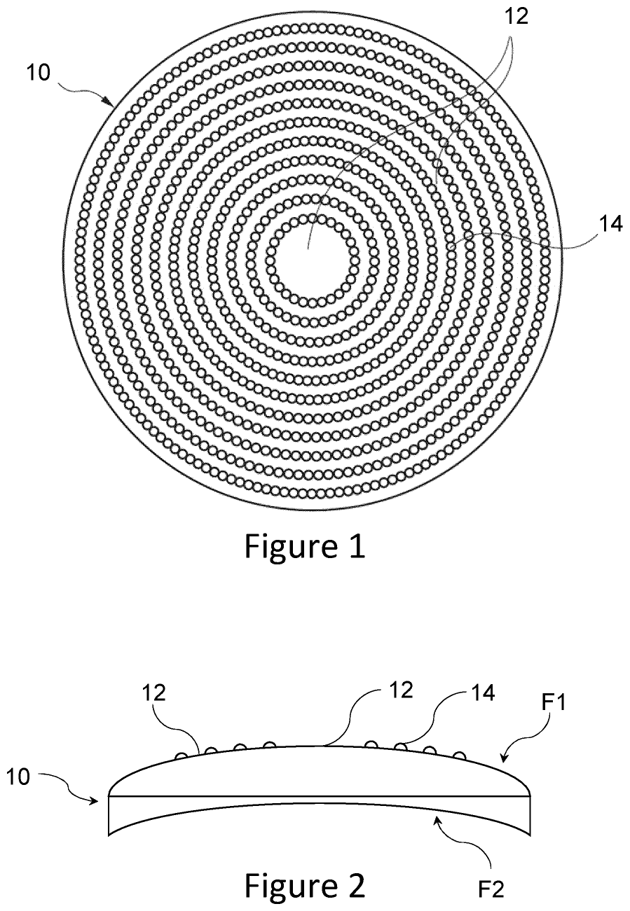

As represented in FIGS. 1 to 3, the optical lens 10 according to the disclosure comprises a refraction area 12 and a plurality of optical elements 14.

As represented in FIG. 2, the optical lens comprises at least a first surface and a second surface opposed to the second surface. For example, the first surface may comprise an object side surface F1 formed as a convex curved surface toward an object side and the second surface may comprise an eye side surface F2 formed as a concave surface having a different curvature than the curvature of the object side surface. The lens element 10 may be made of organic material, thermoset or thermoplastic material, for example polycarbonate, or made of mineral material such as glass.

The refraction area 12 has a refractive power Px based on the prescription of the eye of the wearer, for example of the person for which the optical lens is adapted. The prescription is for example adapted for correcting an abnormal refraction of the eye of the wearer of the optical lens.

The term “prescription” is to be understood to mean a set of optical characteristics of optical power, of astigmatism, of prismatic deviation, determined by an ophthalmologist or optometrist in order to correct the vision defects of the eye, for example by means of a lens positioned in front of his eye. For example, the prescription for a myopic eye comprises the values of optical power and of astigmatism with an axis for the distance vision.

The prescription may comprise an indication that the eye of the wearer has no defect and that no refractive power is to be provided to the wearer. In such case the refractive area is configured so as to not provide any refractive power.

The refraction area is preferably formed as the area other than the areas formed of the plurality of optical elements. In other words, the refraction area is the complementary area to the areas formed of the plurality of optical elements.

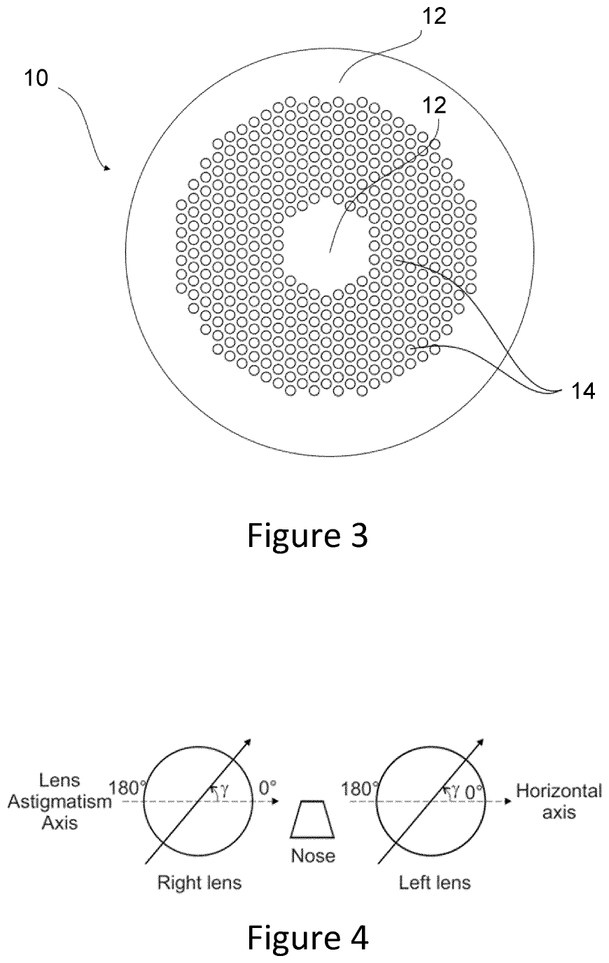

As illustrated in FIGS. 1 and 3, the refraction area 12 may comprise at least the central zone of the optical lens 10.

The central zone may have a characteristic dimension greater than 4 mm and smaller than 22 mm, for example smaller than 20 mm.

The central zone may be centered on a reference point of the optical lens 10. The reference point on which the central zone may be centered is either one of a geometrical center and/or an optical and/or a near vision reference point and/or a far vision reference point of the optical lens.

Preferably, the central zone is centered on, or at least comprises a framing reference point that faces the pupil of the wearer gazing straight ahead in standard wearing conditions.

The wearing conditions are to be understood as the position of the optical lens with relation to the eye of a wearer, for example defined by a pantoscopic angle, a Cornea to lens distance, a Pupil-cornea distance, a center of rotation of the eye (CRE) to pupil distance, a CRE to lens distance and a wrap angle.

The Cornea to lens distance is the distance along the visual axis of the eye in the primary position (usually taken to be the horizontal) between the cornea and the back surface of the lens; for example equal to 12 mm.

The Pupil-cornea distance is the distance along the visual axis of the eye between its pupil and cornea; usually equal to 2 mm.

The CRE to pupil distance is the distance along the visual axis of the eye between its center of rotation (CRE) and cornea; for example equal to 11.5 mm.

The CRE to lens distance is the distance along the visual axis of the eye in the primary position (usually taken to be the horizontal) between the CRE of the eye and the back surface of the lens, for example equal to 25.5 mm.

The pantoscopic angle is the angle in the vertical plane, at the intersection between the back surface of the lens and the visual axis of the eye in the primary position (usually taken to be the horizontal), between the normal to the back surface of the lens and the visual axis of the eye in the primary position; for example equal to −8°, preferably equal to 0°.

The wrap angle is the angle in the horizontal plane, at the intersection between the back surface of the lens and the visual axis of the eye in the primary position (usually taken to be the horizontal), between the normal to the back surface of the lens and the visual axis of the eye in the primary position for example equal to 0°.

An example of standard wearing condition may be defined by a pantoscopic angle of −8°, a Cornea to lens distance of 12 mm, a Pupil-cornea distance of 2 mm, a CRE to pupil distance of 11.5 mm, a CRE to lens distance of 25.5 mm and a wrap angle of 0°.

Another example of standard wearing condition more adapted for younger wearers may be defined by a pantoscopic angle of 0°, a Cornea to lens distance of 12 mm, a Pupil-cornea distance of 2 mm, a CRE to pupil distance of 11.5 mm, a CRE to lens distance of 25.5 mm and a wrap angle of 0°.

An example of standard wearing condition for a contact lens may be defined by a pantoscopic angle of 0°, a Cornea to lens distance of 0 mm, a Pupil-cornea distance of 2 mm, a CRE to pupil distance of 11.5 mm, a CRE to lens distance of 13.5 mm and a wrap angle of 0°.

The central zone of the optical lens may comprise the optical center of the optical lens and have a characteristic dimension greater than 4 mm—corresponding to +/−8° peripheral angle on the retina side, and smaller than 22 mm corresponding to +/−44° peripheral angle on the retina side, for example smaller than 20 mm corresponding to +/−40° peripheral angle on the retina side. The characteristic dimension may be a diameter or the major or minor axes of an ellipse shaped central zone.

The refraction area 12 may further comprise at least a second refractive power Pp different from the prescribed refractive power Px. In the sense of the disclosure, the two refractive powers are considered different when the difference between said refractive powers is greater than or equal to 0.25 D, for example greater than 0.5 D.

When the refractive power Px is prescribed to compensate a myopia of the eye of the wearer, the second refractive power Pp may be greater than the refractive power Px.

When the refractive power Px is prescribed to compensate hyperopia of the eye of the wearer, the second refractive power Pp may be smaller than the refractive power Px.

The refraction area 12 may comprise a continuous variation of refractive power. For example, the refractive area may have a progressive addition design. The optical design of the refraction area may comprise a fitting cross where the optical power is negative, and a first zone extending in the temporal side of the refractive are when the lens element is being worn by a wearer. In the first zone, the optical power increases when moving towards the temporal side, and over the nasal side of the lens, the optical power of the ophthalmic lens is substantially the same as at the fitting cross. Such optical design is disclosed in greater details in WO2016/107919.

Alternatively, the refractive power in the refraction area 12 may comprise at least one discontinuity.

As illustrated in FIGS. 1 to 3, the optical lens 10 comprises a plurality of optical elements.

At least 50%, for example at least 80%, for example all, of a surface of the optical element 10 may be covered by at least one layer of coating element. The at least one layer of coating element may comprise features selected from the group consisting of anti-scratch, anti-reflection, anti-smudge, anti-dust, UV30 filtration, blue light-filtration, anti-abrasion features.

The layer of coating element may be provided using any known techniques. For example, the layer of coating may be provided using a dipping process where the optical lens simultaneously receives a layer of coating on each surface.

The optical elements have a transparent optical function of not focusing an image on the retina of the eye of the wearer when the optical lens is worn in standard wearing conditions.

In other words, when the wearer wears the lens element, for example in standard wearing conditions, rays of light passing through the plurality of optical elements do not focus on the retina of the eye of the wearer, in particular in the peripherical part of the retina of the wearer. For example, the optical elements may focus in front and/or behind the retina of the eye of the wearer.

Advantageously, not focusing an image on the retina of the wearer allows creating a control signal that suppresses, reduces, or at least slows down the progression of abnormal refractions, such as myopia or hyperopia, of the eye of the person wearing the lens element.

In the sense of the disclosure, an optical element is considered to have a transparent optical function when said optical element absorbs less than 50%, for example less than 80%, for example less than 95% of the light over the visible spectrum, i.e. 380 nm to 750 nm.

The inventors have observed that to have a high level of acceptance of myopia control optical lenses among children and teenagers, the aesthetic aspect of the optical lens is of great importance.

In particular the inventors have found that myopia control optical lenses having similar 60° specular gloss levels over a central zone, for example at the optical center, of the optical lens and over a periphery zone, for example at the periphery, of the optical lens increases the level of acceptance of the myopia control lenses by children and teenager and in particular the time spent using such myopia control lenses over the day.

Several studies describe factors associated with compliance in wearing glasses in school-aged children and identify that school-aged children are preoccupied or teased about the appearance of eyeglasses such as Castanon Holguin A M, Congdon N, Patel N, Ratcliffe A, Esteso P, Toledo Flores S, Gilbert D, Pereyra Rito M A, Munoz B. Factors associated with spectacle-wear compliance in school-aged Mexican children. Invest Ophthalmol Vis Sci. 2006 March; 47(3):925-8. doi: 10.1167/iovs.05-0895—PMID: 16505025 or von-Bischhoffshausen F B, Muñoz B, Riquelme A, Ormeño M J, Silva J C. Spectacle-wear compliance in school children in Concepción Chile. Ophthalmic Epidemiol. 2014 December; 21(6):362-9. doi: 10.3109/09286586.2014.975823. Epub 2014 Oct. 30—PMID: 25356984.

Visual gloss is a second order attribute of visual appearance. It has been redefined in 2006 by the International Commission on Illumination (CIE) as the mode of appearance by which reflected highlights of objects are perceived as superimposed on the surface due to the directionally selective properties of that surface (International Lighting Vocabulary (e-ILV) definition 17-24-080).

Visual gloss is a complex construction from the visual system. It is now described as a “gestalt”, i.e. a multidimensional psychophysical quantity.

In order to segment the dimensionality of gloss, R. S Hunter described in the 1920s gloss classes, among which specular gloss.

Specular gloss measurement is a technique that was developed to answer industrial concerns regarding the visual aspect of cars hardcoats at that time. Glossmeters are widely used in the paint and automotive industries. It is described by two main standards: ISO 2813:2014 and ASTM D523.

The measured quantity is a gloss index, expressed in gloss units (GU). The gloss index is a flux ratio between the sample to be test and a glass standard within fixed apertures of illumination and detection. The standard, provided with the measuring instrument, has a specific geometry and refractive index, it is traceable to National Metrology Institutes. It is measured in three fixed geometries for illumination and detection: 20°:20°, 60°:60° and 85°:85°.

A common approach is to use the 60° configuration to first assess the sample reflective properties and propose other measurements accordingly, the more mat, the more grazing angle of illumination.

The inventors have used glossmeters dedicated to small apertures to remain within the scope of ISO2813:2014.

The inventors have also chosen to work with distinctness of image gloss (DOI) measurements. DOI is a quantity derived from specular gloss, calculated by the glossmeter as the variation of Reflectance within a given angular range:

$$DOI ∝ \frac{Δ Reflectance}{Δ Angle}$$

DOI is also standardized in ASTM D5767-18

In order to stick to the domain methods, the inventors chose to use a Glossmeter with a reduced detection size to restrict the lens curvature effects to a minimum.

To measure accurately the 60° specular gloss level and the distinctness of image gloss (DOI) the optical lens may need to be prepared, in particular the surface of the optical lens not carrying the optical elements is to be prepared. For example, the back surface of the optical lens is sanded and then painted with black mat paint.

To compare the 60° specular gloss levels and the distinctness of image gloss (DOI) between the central zone and the peripherical zone of the optical lenses, measurements may be carried out using a pattern as illustrated on FIG. 6.

The skilled person would understand that other patterns or type of measurements may be carried out and may adapted the measurements to the situation.

The inventors have found that average values and standard deviation of the measurements appear to be the most interesting features in relation with the level of acceptance of myopia control optical lenses, in particular by young wearers.

The standard deviations are to be calculated over different regions of the optical lens, defined by center and periphery of the lens. An point of the disclosure is to measure relative variations in the standard deviation caused by the refraction area and the optical elements rather than an absolute value for distinctness of image gloss (DOI) which could be greatly impacted by curvature.

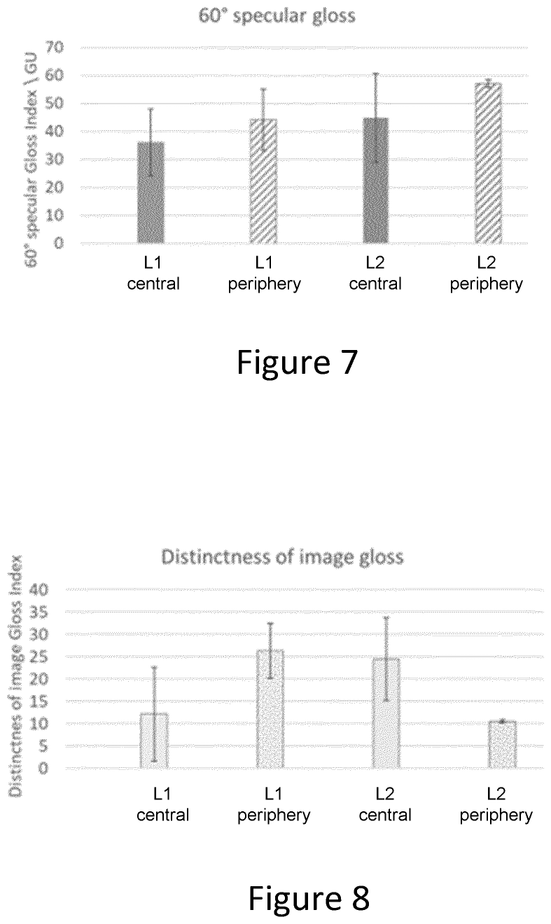

FIG. 7 illustrates 60° specular gloss levels measurements carried out over a central zone, for example at the optical center, of the optical lens and over a periphery zone, for example at the periphery, of an optical lens L1 having a configuration according to FIG. 1 and an optical lens L2 having a configuration according to FIG. 3.

The optical lens according to the disclose has similar 60° specular gloss levels over a central zone, for example at the optical center, of the optical lens and over a periphery zone, for example at the periphery, of the optical lens.

Typically, the 60° specular gloss level is measured over a central zone comprising the optical center of the optical lens and having a characteristic dimension, for example a diameter, greater than or equal to 0.4 mm, for example greater than or equal to 0.5 mm, and smaller than or equal to 0.9 mm, for example smaller than or equal to 0.75 mm.

Typically, the 60° specular gloss level is measured over a periphery zone of the optical lens having a ring shape centered on the optical center of the optical lens and having an inner diameter greater than or equal to 30 mm and smaller than or equal to 40 mm and an outer diameter greater than or equal to 55 mm and smaller than or equal to 70 mm, for example smaller than or equal to 60 mm.

The 60° specular gloss level may be measured over a periphery zone of the optical lens positioned slightly more than half, for example 1.1 time half, the instrument aperture away from the center of the optical center. Advantageously, this assures that the peripheral and central zone measurements do not overlap.

Alternatively, the 60° specular gloss level may be measured over a periphery zone of the optical lens positioned at the middle of the lens radius position.

The 60° specular gloss level is measured in Gloss Units (GU).

As illustrated on FIG. 7, according to an embodiment, the standard deviations of the 60° specular gloss levels measured over a central zone, for example at the optical center, of the optical lens and over a periphery zone, for example at the periphery, of the optical lens overlap.

FIG. 8 illustrates distinctness of image gloss (DOI) measurements carried out over a central zone, for example at the optical center, of the optical lens and over a periphery zone, for example at the periphery, of an optical lens L1 having a configuration according to FIG. 1 and an optical lens L2 having a configuration according to FIG. 3.

An optical lens according to the disclosure may have average distinctness of image gloss (DOI) measured over a central zone, for example at the optical center, of the optical lens and over a periphery zone, for example at the periphery, of the optical lens are greater than or equal to 10 DOI Index.

According to an embodiment of the disclosure, at least 50%, for example at least 80%, for example all, of the optical elements are refractive lenslets, for example aspherical lenslets and at least 50%, for example at least 80%, for example all of the optical elements of the optical lens have an absolute value of cylinder power greater than or equal to 0.1 D, for example greater than or equal to 0.2 D.

As is known, a minimum curvature CURVₘᵢₙ may be defined at any point on an aspherical surface by the formula:

$${CURV}_{min} = \frac{1}{{R}_{max}} ,$$

where Rₘₐₓ is the local maximum radius of curvature, expressed in meters and CURVₘᵢₙ is expressed in diopters.

Similarly, a maximum curvature CURVₘₐₓ can be defined at any point on an aspheric surface by the formula:

$${CURV}_{max} = \frac{1}{{R}_{min}} ,$$

where Rₘᵢₙ is the local minimum radius of curvature, expressed in meters and CURVₘₐₓ is expressed in diopters.

It can be noticed that when the surface is locally spherical, the local minimum radius of curvature Rmin and the local maximum radius of curvature Rmax are the same and, accordingly, the minimum and maximum curvatures CURVmin and CURVmax are also identical. When the surface is aspherical, the local minimum radius of curvature Rmin and the local maximum radius of curvature Rmax are different.

From these expressions of the minimum and maximum curvatures CURVmin and CURVmax, the minimum and maximum spheres labeled SPHmin and SPHmax can be deduced according to the kind of surface considered.

When the surface considered is the object side surface (also referred to as the front surface), the expressions are the following:

$${SPH}_{min} = ( n - 1 ) * {CURV}_{min} = \frac{n - 1}{{R}_{max}} and {SPH}_{max} = ( n - 1 ) * {CURV}_{max} = \frac{n - 1}{{R}_{min}}$$

where n is the refraction index of the constituent material of the lens.

If the surface considered is an eyeball side surface (also referred to as the back surface), the expressions are the following:

$${SPH}_{min} = ( 1 - n ) * {CURV}_{min} = \frac{1 - n}{{R}_{max}} and {SPH}_{max} = ( 1 - n ) * {CURV}_{max} = \frac{1 - n}{{R}_{min}}$$

where n is the refraction index of the constituent material of the lens.

As is well known, a mean sphere SPHₘₑₐₙ at any point on an aspherical surface can also be defined by the formula:

$${SPH}_{mean} = \frac{1}{2} ( {SPH}_{min} + {SPH}_{max} )$$

The expression of the mean sphere therefore depends on the surface considered:
if the surface is the object side surface,

$${SPH}_{mean} = \frac{n - 1}{2} ( \frac{1}{{R}_{min}} + \frac{1}{{R}_{max}} )$$

if the surface is an eyeball side surface,

$${SPH}_{mean} = \frac{1 - n}{2} ( \frac{1}{{R}_{min}} + \frac{1}{{R}_{max}} )$$

A cylinder CYL is also defined by the formula CYL=|SPHₘₐₓ−SPHₘᵢₙ.

The characteristics of any aspherical face of the lens may be expressed by the local mean spheres and cylinders.

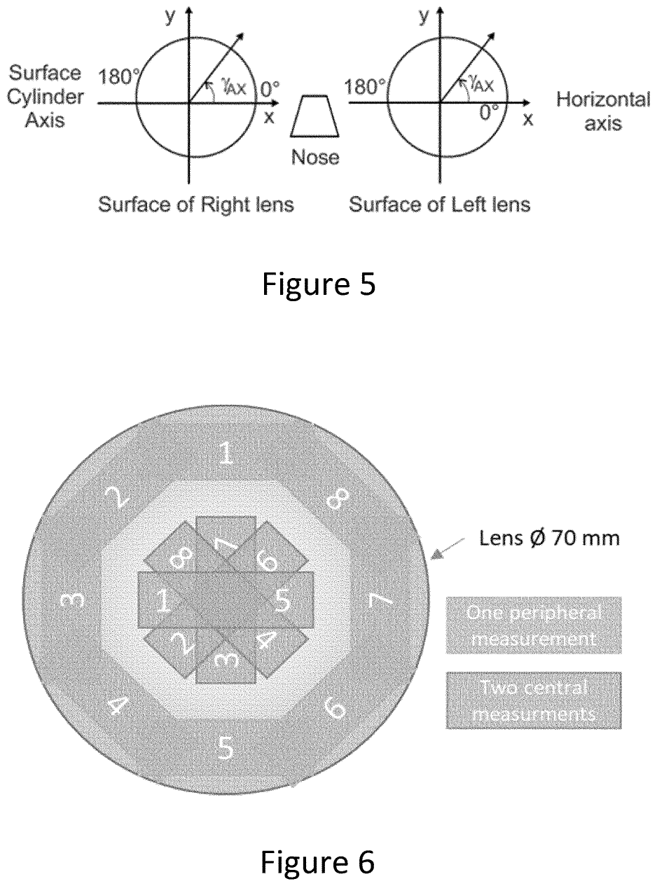

For an aspherical surface, a local cylinder axis γ_{AX} may further be defined. FIG. 4 illustrates the astigmatism axis y as defined in the TABO convention and FIG. 5 illustrates the cylinder axis γ_{AX} in a convention defined to characterize an aspherical surface.

The cylinder axis γ_{AX} is the angle of the orientation of the maximum curvature CURVₘₐₓ with relation to a reference axis and in the chosen sense of rotation. In the above defined convention, the reference axis is horizontal (the angle of this reference axis is 0°) and the sense of rotation is counterclockwise for each eye, when looking at the wearer (0°≤γ_{AX}≤180°). An axis value for the cylinder axis γ_{AX} of +45° therefore represents an axis oriented obliquely, which when looking at the wearer, extends from the quadrant located up on the right to the quadrant located down on the left.

At least part, for example more than 50%, preferably all, of the optical elements 14 may be lenslet having a contour shape being inscribable in a circle having a diameter greater than or equal to 0.2 mm, for example greater than or equal to 0.4 mm, for example greater than or equal to 0.6 mm, for example greater than or equal to 0.8 mm and smaller than or equal to 2.0 mm, for example smaller than or equal to 1.0 mm.

For example, the area of each optical elements is greater than or equal to 0.4 mm² and smaller than or equal to 5 mm², for example smaller than or equal to 4 mm².

The ratio of the total area of the optical elements with respect to the total area of the surface of the optical lens may be greater than or equal 20% and smaller than or equal to 80%.

As illustrated on FIG. 2, at least part, for example all, of the optical elements 14 may be located on the front surface of the optical lens. The front surface of the lens element corresponds to the object side F1 of the lens element facing towards the object.

At least part, for example all, of the optical elements 14 may be located on the back surface of the optical lens. The back surface of the lens element corresponds to the eye side F2 of the lens element facing towards the eye.

At least part, for example all, of the optical elements 14 may be located between the front and the back surfaces of the optical lens, for example when the lens element is encapsulated between two lens substrates. Advantageously, it provides a better protection to the optical elements.

For every circular zone having a radius comprised between 2 and 4 mm comprising a geometrical center located at a distance of the optical center of the optical lens greater or equal to said radius+5 mm, the ratio between the sum of areas of the optical elements 14 located inside said circular zone and the area of said circular zone may be comprised between 20% and 70%.

The optical elements may be randomly distributed on the lens element.

Alternatively, and as illustrated in FIG. 1, least 50%, for example at least 80%, for example all, of the optical elements are positioned along at least 5 concentric rings and wherein the concentric rings are none contiguous one with the others. The concentric rings may be annular rings.

Advantageously, such configuration provides a great balance between the slowdown of the abnormal refraction of the eye of the wearer and the visual performances or comfort of the wearer.

The optical lens may comprise optical elements disposed in at least two concentric rings, preferably more than 5, more preferably more than 10 concentric rings. For example, the optical elements may be disposed in 11 concentric rings centered on the optical center of the optical lens.

The diameter of all optical elements on a concentric ring of the lens element may be substantially identical. For example, all the optical elements on the lens element have a substantially identical diameter.

The inventors have determined that with such configuration the difference of standard deviation of the 60° specular gloss levels measured over a central zone, for example at the optical center, of the optical lens and over a periphery zone, for example at the periphery, of the optical lens may be smaller than or equal to 2 GU, for example smaller than 1.2 GU. This illustrates that with the proposed configuration of FIG. 1 provides a high level of aesthetic and repeatability in the measurements. Advantageously, the level of acceptance of the optical lens, in particular among young wearer is improved.

The inventors have also determined that for an optical lens illustrated on FIG. 1 the standard deviations of the distinctness of image gloss (DOI) measured over a central zone, for example at the optical center, of the optical lens and over a periphery zone, for example at the periphery, of the optical lens overlap.

The inventors have also determined that for an optical lens having at least 50%, for example at least 80%, for example all, of the optical elements are positioned along at least 5 concentric rings and wherein the concentric rings are none contiguous one with the others the average distinctness of image gloss (DOI) measured over a periphery zone, for example at the periphery, of the optical lens are greater than or equal to 20 DOI Index, for example greater than or equal to 25 DOI Index and smaller than or equal to 35 DOI Index, for example smaller than or equal to 30 DOI Index.

Alternatively, at least 50%, for example at least 80%, for example all of the optical elements are positioned on the lens element on a mesh, for example a structured mesh. The structured mesh may be a squared mesh or a hexagonal mesh or a triangle mesh or an octagonal mesh or a honeycomb mesh. Alternatively, the mesh structure may be a random mesh, for example a Voronoi mesh.

FIG. 3 illustrates an embodiment wherein the optical elements are positioned on a honeycomb mesh.

As illustrated on FIG. 7, for an optical lens having optical elements positioned on a structured mesh such as a honeycomb mesh, the difference of standard deviation of the 60° specular gloss levels measured over a central zone, for example at the optical center, of the optical lens and over a periphery zone, for example at the periphery, of the optical lens is greater than or equal to 5 GU.

As illustrated on FIG. 7, for an optical lens having optical elements positioned on a structured mesh such as a honeycomb mesh, the standard deviation of the 60° specular gloss level measured over a periphery zone, for example at the periphery, of the optical lens is smaller than or equal to 2 GU, for example smaller than or equal to 1.5 GU.

As illustrated on FIG. 8, for an optical lens having optical elements positioned on a structured mesh such as a honeycomb mesh, the standard deviations of the distinctness of image gloss (DOI) measured over a central zone, for example at the optical center, of the optical lens and over a periphery zone, for example at the periphery, of the optical lens do not overlap.

As illustrated on FIG. 8, for an optical lens having optical elements positioned on a structured mesh such as a honeycomb mesh, the standard deviations of the distinctness of image gloss (DOI) measured over a periphery zone, for example at the periphery, of the optical lens is smaller than or equal to 2 DOI Index.

As illustrated on FIG. 8, for an optical lens having optical elements positioned on a structured mesh such as a honeycomb mesh, the standard deviations of the distinctness of image gloss (DOI) measured over a periphery zone, for example at the periphery, of the optical lens is smaller than or equal to 2 DOI Index.

The disclosure has been described above with the aid of embodiments without limitation of the general inventive concept. Many further modifications and variations will be apparent to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. An optical lens intended to be worn by a wearer comprising:
a refraction area having a refractive power based on a prescription of the wearer; and
a plurality of optical elements each having a transparent optical function of not focusing an image on a retina of an eye of the wearer when the optical lens is worn in standard wearing conditions,
wherein 60° specular gloss levels over a central zone of the optical lens and over a periphery zone of the optical lens are similar.

2. The optical lens according to claim 1, wherein standard deviations of the 60° specular gloss levels measured over a central zone of the optical lens and over a periphery zone of the optical lens overlap.

3. The optical lens according to claim 1, wherein average distinctness of image gloss (DOI) measured over a central zone of the optical lens and over a periphery zone of the optical lens are greater than or equal to 10 DOI Index.

4. The optical lens according to claim 1, wherein at least part of one of a front or back surface of the optical lens comprises at least one layer of at least one coating element covering at least part of surfaces on which the optical elements are placed.

5. The optical lens according to claim 1, wherein at least 50% of the optical elements are located on one of surfaces of the optical lens.

6. The optical lens according to claim 1, wherein at least 50% of the optical elements are located between front and back surfaces of the optical lens.

7. The optical lens according to claim 1, wherein at least 50% of the optical elements are refractive lenslets.

8. The optical lens according to claim 1, wherein at least 50% of the optical elements are positioned along at least 5 concentric rings and wherein the concentric rings are none contiguous one with the others.

9. The optical lens according to claim 8, wherein a difference of standard deviation of the 60° specular gloss levels measured over a central zone of the optical lens and over a periphery zone of the optical lens is smaller than or equal to 2 GU.

10. The optical lens according to claim 8, wherein standard deviations of distinctness of image gloss (DOI) measured over a central zone of the optical lens and over a periphery zone of the optical lens overlap.

11. The optical lens according to claim 1, wherein at least 50% of the optical elements are positioned on a structured mesh, the structured mesh being a squared mesh or a honeycomb mesh or a triangle mesh or an octagonal mesh.

12. The optical lens according to claim 11, wherein a difference of standard deviation of the 60° specular gloss levels measured over a central zone of the optical lens and over a periphery zone of the optical lens is greater than or equal to 5 GU.

13. The optical lens according to claim 11, wherein a standard deviation of the 60° specular gloss level measured over a periphery zone of the optical lens is smaller than or equal to 2 GU.

14. The optical lens according to claim 11, wherein standard deviations of distinctness of image gloss (DOI) measured over a central zone of the optical lens and over a periphery zone of the optical lens do not overlap.

15. The optical lens according to claim 11, wherein standard deviations of distinctness of image gloss (DOI) measured over a periphery zone of the optical lens is smaller than or equal to 2 DOI Index.
